(19) United States
(12) Patent Application Publication
(10) Pub. No.: US 2026/0163722 A1
(43) Pub. Date: Jun. 11, 2026

(54) UTILIZING POINTERS FOR MANAGING PRODUCT LIFECYCLE DATA IN PLM SYSTEMS

(71) Applicant: The Boeing Company, Arlington, VA (US)

(72) Inventor: Vinh Tat, Renton, WA (US)

(21) Appl. No.: 18/972,646

(22) Filed: Dec. 6, 2024

(51) Int. Cl. H04L 9/08; H04L 9/32

(52) U.S. Cl. CPC H04L 9/0825; H04L 9/3263

(57) ABSTRACT

One example provides a method for operating a verdict retriever module configured to programmatically interface with a product lifecycle management (PLM) system. The method comprises receiving a change data request for a part reference object in the PLM system. The method further comprises sending a verdict request based at least upon the change data request to the PLM system and in response, receiving a verdict response. The method also comprises sending a request to publish data to a control gate module and in response, receiving a pointer to a storage location in a data warehouse. The method additionally comprises transferring the pointer to the PLM system to record the pointer in relation to the part reference object, and sending at least the verdict response to a source of the change data request.

### FIELD

The disclosed examples relate to managing product lifecycle data with large file sizes in relation to bill of materials (BOM) structures of a product lifecycle management (PLM) system.

### BACKGROUND

In some manufacturing environments, product inspections have become an essential part of the manufacturing process. In some industries, product lifecycle data from the product inspections need to be retained. For example, measurement data generated from product inspections of an aircraft during manufacturing are retained for compliance with regulations of the Federal Aviation Administration (FAA) of the Unites States of America. Further, the product lifecycle data may also need to be retained to support audits and/or investigations as well as for process improvement(s). Except for small summary files, storing very large product lifecycle data can impair operational performance of a product lifecycle management (PLM) system. This leads to a multitude of one-off data retention practices, often disconnected from the authoritative PLM system, resulting in possible access without proper authorization and/or overwritten/loss of data over time.

### SUMMARY

One example provides a method for operating a verdict retriever module configured to programmatically interface with a product lifecycle management (PLM) system. The method comprises receiving a change data request for a part reference object in the PLM system. The method further comprises sending a verdict request based at least upon the change data request to the PLM system and in response, receiving a verdict response. The method also comprises sending a request to publish data to a control gate module, and in response, receiving a pointer to a storage location in a data warehouse. The method additionally comprises transferring the pointer to the PLM system to record the pointer in relation to the part reference object, and sending at least the verdict response to a source of the change data request.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a block diagram of an example computing system utilizing a data warehouse and a PLM system for managing product lifecycle data.

FIG. 2 schematically illustrates a data flow of product lifecycle data of the computing system of FIG. 1 with reference to ISA-95 levels.

FIG. 3. illustrates a block diagram of an example product object model in a PLM system.

FIG. 4 schematically depicts an example communication flow for transferring product lifecycle data to the data warehouse of FIG. 1.

FIG. 5 schematically depicts an example communication flow for establishing a secure connection to transfer the product lifecycle data.

FIG. 6 illustrates an example communication flow for an access control request.

FIG. 7 illustrates an example communication flow for a configuration management request.

FIG. 8 schematically depicts an example of an alternate communication flow for transferring the product lifecycle data to the data warehouse of FIG. 1

FIG. 9 schematically depicts an example communication flow for updating pointers for moved product lifecycle data in the data warehouse of FIG. 1.

FIG. 10 shows a flowchart of an example method for operating a verdict retriever module.

FIG. 11 shows a flowchart of an example method for operating a control gate module.

FIG. 12 shows a block diagram of an example computing system.

### DETAILED DESCRIPTION

As mentioned herein above, product lifecycle data from product inspections, for example, in the aircraft industry, are retained for regulatory compliance along with audits and investigations. Additionally, components of an aircraft can be managed through use of BOM (bill of materials) structures in a PLM (product lifestyle management) system. Such relational information of the components can help enable traceability of product lifecycle data relevant to a specific aircraft. Therefore, it is beneficial for the product lifecycle data to be stored in the PLM system to retain a relationship to the BOM structure. However, some of the product lifecycle data can include large files, such as three-dimensional point clouds from laser scans. Such large data files can significantly degrade the performance of the PLM system.

One possible solution is to store the product lifecycle data in an external repository. However, the external repository might not have the same access control and configuration management decision capabilities as the PLM system. Without these decision capabilities, product lifecycle data in the external repository can be accessed without proper authorization and/or unintentionally overwritten and/or lost over time.

Another possible solution is to replicate the access control and configuration management decision capabilities of the PLM system in an external repository. However, such decision capabilities can be complex, for example, as access control and configuration management rules are tied to the BOM structure. Further, the external repository does not have a BOM structure which means part of the BOM structure of the PLM system may need to be replicated. Further, replicating the decision capabilities as such relies on knowledge of internal models of the PLM system and an ability to implement similar models. More particularly, engineering resources are needed to understand how the PLM system performs the decision capabilities and then to develop, test, and deploy the similar models for the external repository. Such engineering resources can increase headcount and/or schedule time to project development. Also, it can be difficult to keep the replicated models up-to-date with changes on the PLM system. Therefore, replicating such decision capabilities can be complex and costly to implement and/or maintain.

Accordingly, examples are disclosed that relate to extracting verdict responses from a PLM system for controlling access to and managing configuration of product lifecycle data stored in locations outside of the PLM system. Here, a verdict response indicates an access control and configuration management decision of the PLM system. Briefly, a computing system includes a PLM system and a data warehouse for retaining relevant product lifecycle data. As used herein, the term “product lifecycle data” refers to suitable data relevant to an object (e.g., related to a part and/or product) in the PLM system. An inspection/measurement system is configured to generate the product lifecycle data during manufacturing, maintenance, repair, or other phases of the product lifecycle. Further, the product lifecycle data can include measurement data, test data, inspection data, or other suitable data that is beneficial to be retained.

A verdict retriever module is configured to obtain a verdict response from the PLM system. The verdict retriever module is also configured to form a trust relationship with a control gate module. Here, the control gate module is operatively coupled to the data warehouse for controlling access to and managing configuration of the product lifecycle data stored in the data warehouse using the verdict response forwarded from the verdict retriever module. When the verdict response comprises an approve response, the control gate module can send, to the verdict retriever module, a pointer to a storage location in the data warehouse where the product lifecycle data will be stored. Further, the verdict retriever module can transfer the pointer to the PLM system to record the pointer in relation to the part reference object within a BOM structure. Additionally, the control gate module can receive the product lifecycle data over a secure connection, either via the verdict retriever module or directly from a user agent module of the inspection/measurement system. As used herein, the term “secure connection” generally indicates a network connection that is authenticated by endpoints of the network connection for communication with desired security and/or trust. The control gate module can further transfer the product lifecycle data to the storage location. In such a manner, the data warehouse provides an external repository for product lifecycle data while leveraging the access control and configuration management capabilities of the PLM system. This beneficially helps to retain the product lifecycle data in relation to the BOM structure while not overwhelming the PLM system with large files. Thus, the verdict retriever module and the control gate module can help to significantly reduce the amount of engineering resources and cost in building and/or maintaining an external repository compared to replicating the access control and configuration management capabilities of the PLM system.

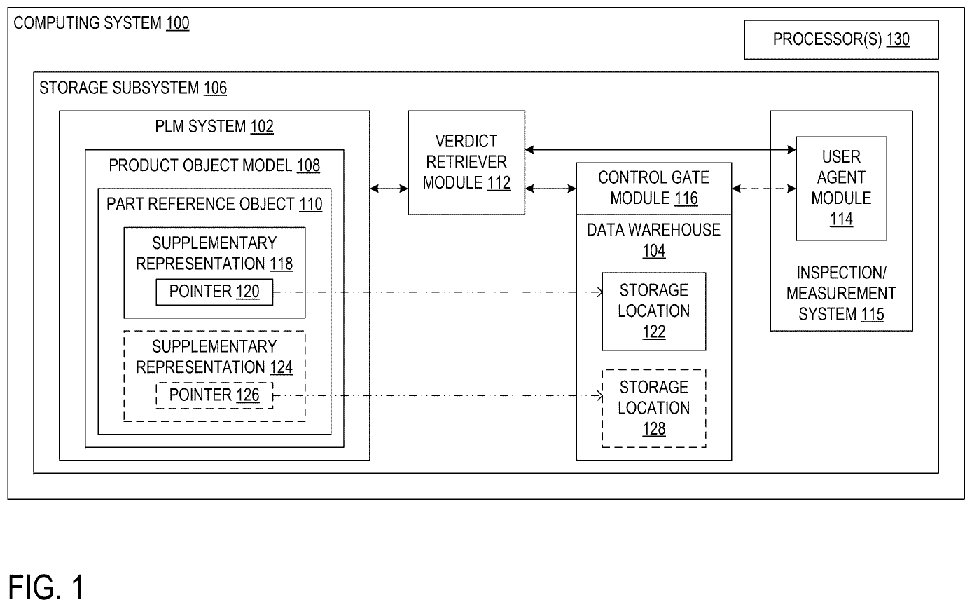

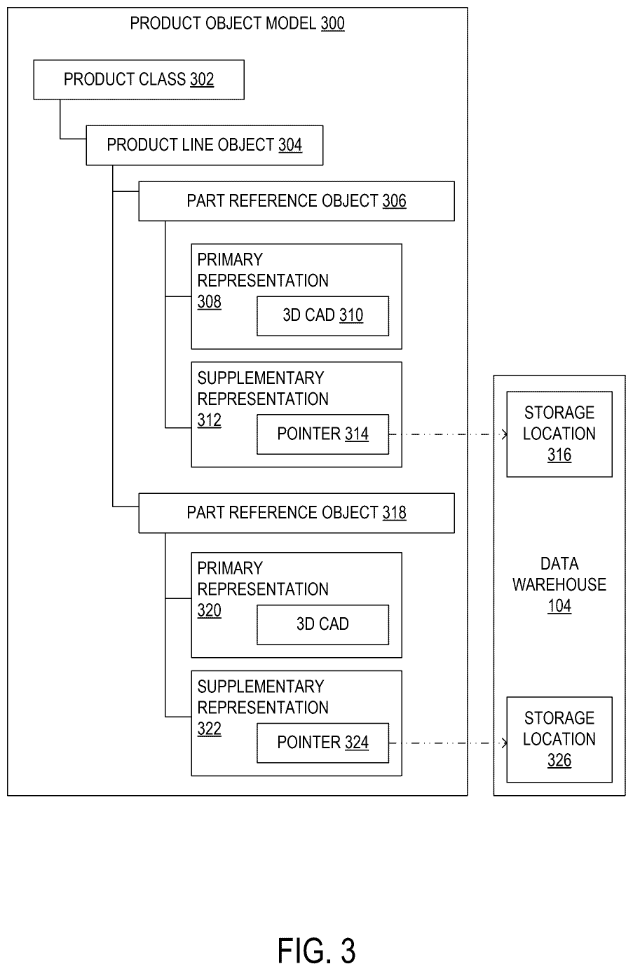

FIG. 1 depicts a block diagram of an example computing system 100 utilizing a PLM system 102 and an associated external repository in the form of a data warehouse 104. The computing system 100 comprises a storage subsystem 106 including the PLM system 102 and the data warehouse 104. Here, the PLM system 102 is configured to manage a BOM structure and suitable components related to a product. The product can include vehicles (e.g., aircraft, automobiles, drones, etc.), medical devices, computing components, components for physical structures (e.g., elevators), infrastructure (e.g., bridges, electrical grids, dams, etc.), and any other suitable product where product lifecycle data is retained. In some examples, the PLM system 102 can also retain product lifecycle data relating to components in the BOM structure, such as throughout the life of an aircraft, for example. Here, the PLM system 102 includes a product object model 108 that represents an aircraft product line. As will be discussed in more detail below, the product object model 108 includes at least a part reference object 110 representing a specific part on a specific aircraft. The PLM system 102 is also configured to provide a verdict response indicating an access control and configuration management decision for the part reference object 110. An example of a product object module is discussed with reference to FIG. 3.

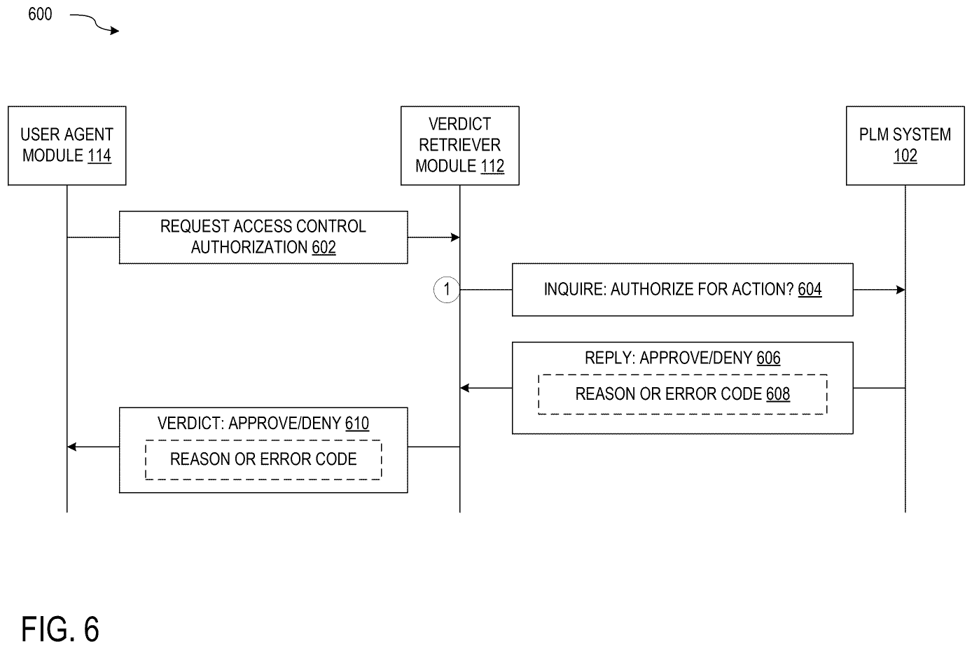

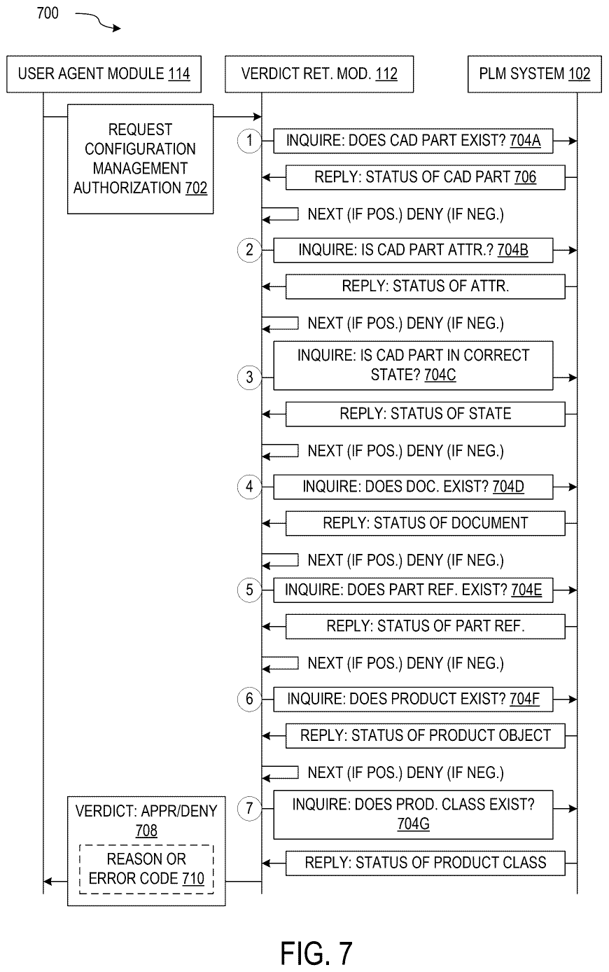

The storage subsystem 106 also includes a verdict retriever module 112 configured to obtain the verdict response from the PLM system 102. Briefly, the verdict retriever module 112 sends a verdict request to the PLM system 102 based at least upon a change data request for the part reference object 110 received from a user agent module 114. In some examples, the user agent module 114 can comprise an application programming interface (API) (not depicted in FIG. 1) that responds to inputs from an inspection/measurement system 115 that an end user operates. Further, the verdict retriever module 112 is configured to establish a trust relationship with a control gate module 116 operatively coupled to the data warehouse 104. Here, the control gate module 116 can grant access to and/or manage configuration of the product lifecycle data stored in the data warehouse 104 by enforcing the verdict response forwarded from the verdict retriever module 112. Examples of obtaining a verdict response are discussed with reference to FIGS. 6 and 7.

Additionally, the control gate module 116 is configured to respond with a pointer to a storage location, for example, when the verdict response comprises an approve response. The verdict retriever module 112 transfers the pointer to the PLM system 102 to record the pointer in a supplementary representation of the part reference object 110. Here, the storage location is a location (e.g., memory address) to store product lifecycle data associated with the part reference object 110. In the depicted example, the part reference object 110 has a supplementary representation 118 comprising a pointer 120 to a storage location 122 of the product lifecycle data. In some examples, the pointer 120 includes a uniform resource locator (URL) to the storage location 122. Likewise, the part reference object 110 can optionally have an additional supplementary representation 124 comprising another pointer 126 to another storage location 128 of another product lifecycle data associated with the part reference object 110. The other storage location 128 can include a different file of the product lifecycle data (for example, processed measurement data with outlier points removed) than the storage location 122. In other examples, the part reference object 110 can have another configuration and/or one or more than two supplementary representations.

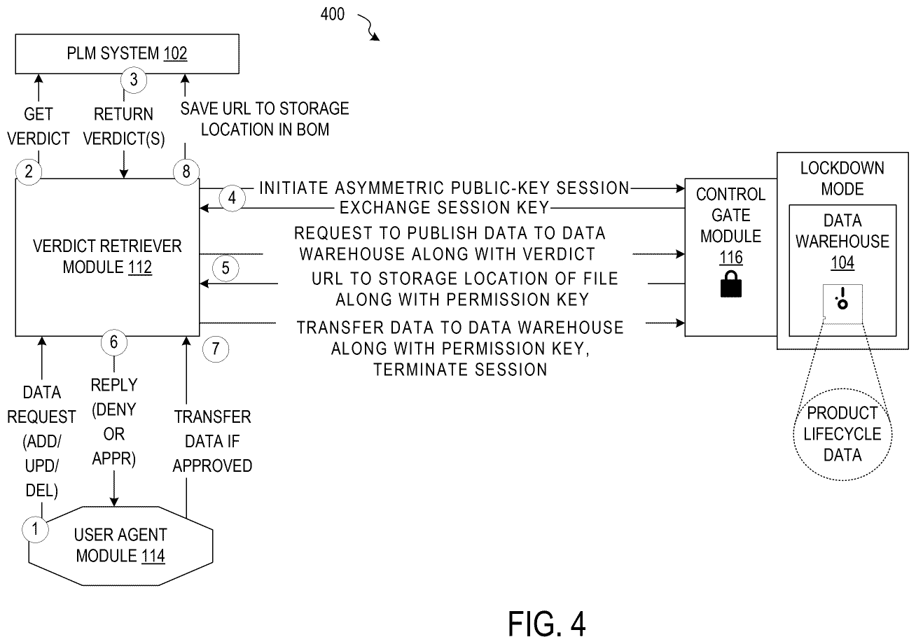

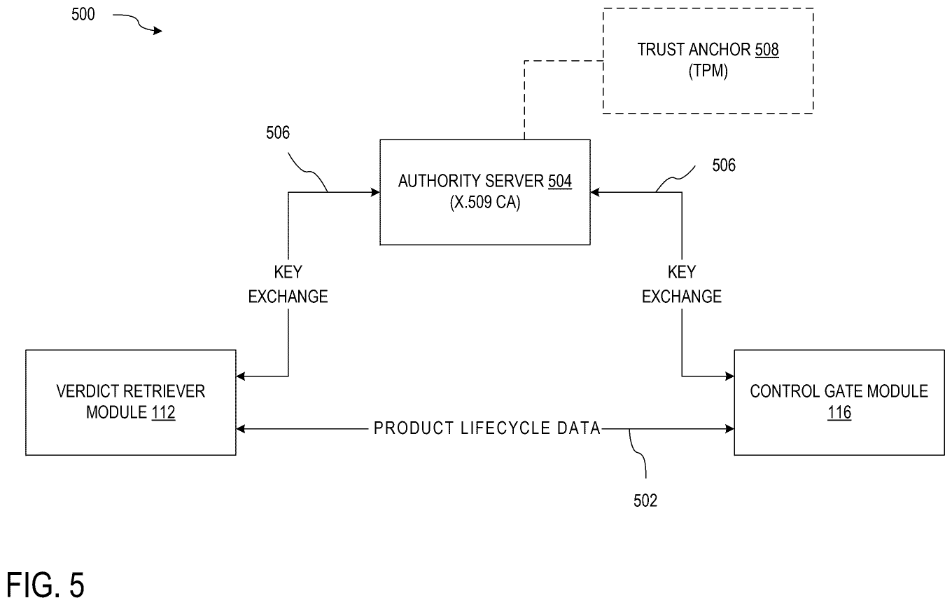

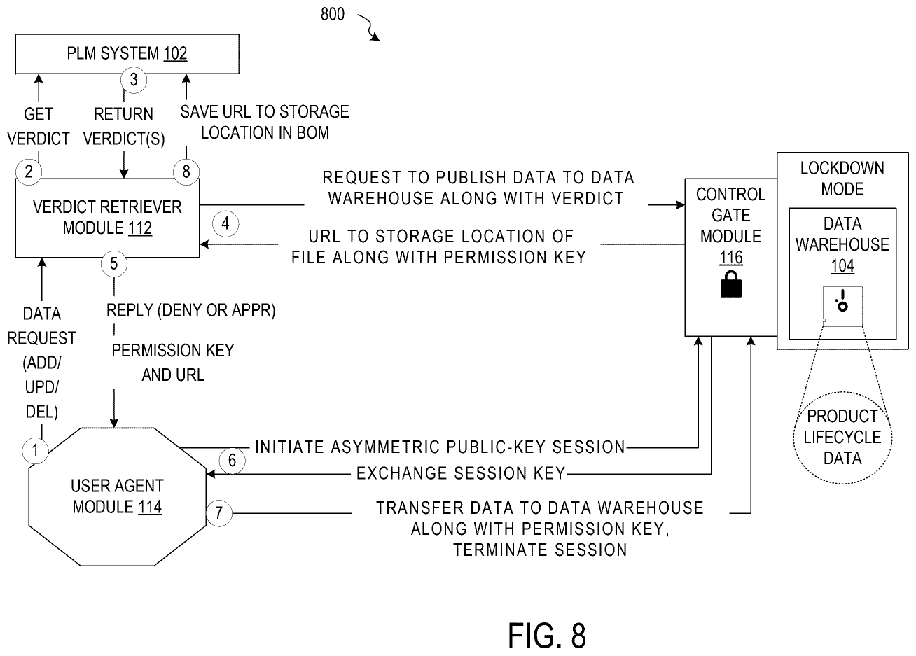

The control gate module 116 is also configured to receive the product lifecycle data over a secure connection. In some examples, the control gate module 116 can receive the product lifecycle data via the verdict retriever module 112, as discussed below with reference to FIG. 4. Alternatively or additionally, the control gate module 116 can receive the product lifecycle data directly from the user agent module 114, as discussed below with reference to FIG. 8. Additionally, the control gate module 116 is configured to transfer the data to the relevant storage location (e.g., the storage location 122 or the other storage location 128). The secure connection can be established in any suitable manner, an example of which is discussed below with reference to FIG. 5. The verdict retriever module 112 is configured to establish the secure connection with the control gate module 116. By utilizing pointers as discussed herein above, the product lifecycle data can be stored outside of the PLM system 102 while also having a traceable relationship to the part reference object 110. This enables traceability of the product lifecycle data throughout the lifecycle of an aircraft or another suitable product.

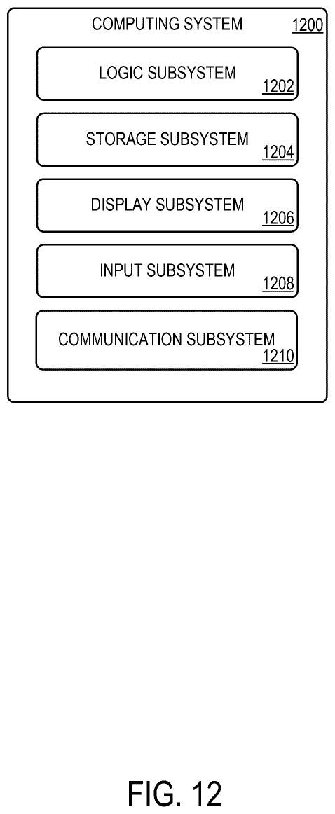

The computing system 100 also includes one or more processors 130 configured to execute various functions of the PLM system 102, the verdict retriever module 112, the control gate module 116, the data warehouse 104, the user agent module 114, and the inspection/measurement system 115. Further aspects of the processors 130 and the storage subsystem 106 are discussed with reference to FIG. 12. While discussed with reference to an aircraft, the computing system 100 can be used to track and retain product lifecycle data for other suitable product lines in other examples. In further examples, other suitable production flows can also utilize the computing system 100 for retaining product lifecycle data in a traceable manner.

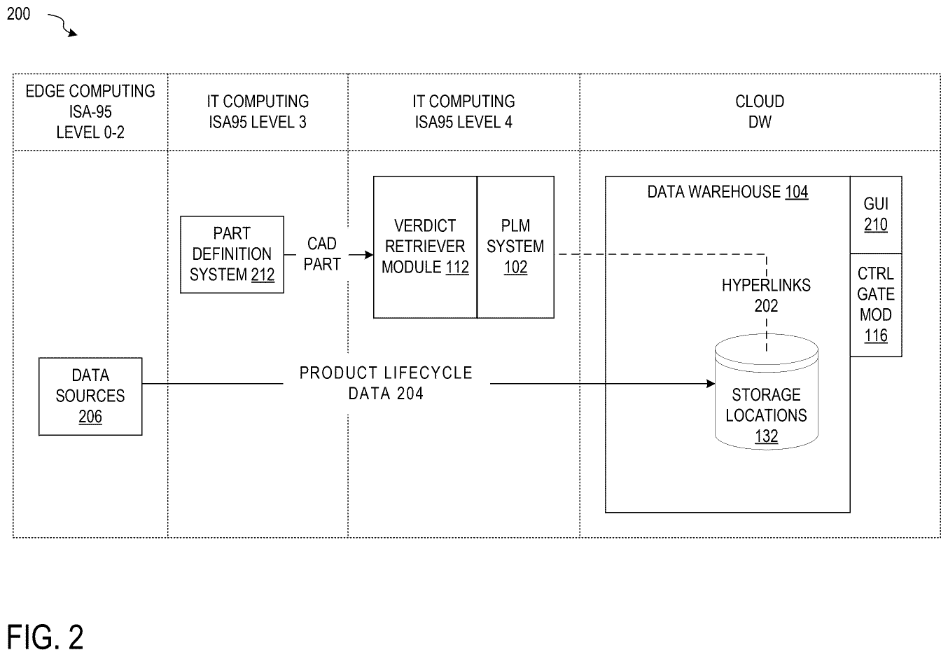

As mentioned herein above, product lifecycle data can be generated during production of an aircraft. Some production flows in a manufacturing organization can be configured according to guidelines established by the International Society of Automation (ISA), such as the ISA-95 for enterprise and control system integration, for example. The ISA-95 defines five levels (e.g., levels 0, 1, 2, 3 and 4) of activities in a manufacturing organization, summarized as follows. Levels 0 to 2 relate to physical processes of a production flow. Level 3 performs manufacturing operations management. Level 4 performs business planning and logistics. A data flow diagram can represent the movement of the product lifecycle data within the context of the ISA-95. Thus, FIG. 2 schematically depicts an example data flow 200 with reference to the ISA-95 levels. Here, the data flow 200 is depicted using the computing system 100. As discussed herein above, the PLM system 102 manages a product object model having pointers (depicted here as hyperlinks 202) to a corresponding plurality of storage locations 132 in the data warehouse 104.

As depicted, product lifecycle data 204 is generated by a plurality of data sources 206 at the ISA-95 levels 0 to 2. The plurality of data sources 206 can include devices that are configured to perform inspections and/or measurements of parts during manufacturing. In some examples, the data sources 206 can also include manufacturing devices (e.g., additive manufacturing devices), testing devices (e.g., for quality assurance), and other suitable devices that monitor and/or sense physical manufacturing processes. In some examples, one or more devices of the data sources 206 can utilize a user agent module to communicate to the verdict retriever module 112 as discussed above with reference to FIG. 1. Additionally, a graphical user interface (GUI) 210 is operationally coupled to the data warehouse 104 for queries, by end-users, of product lifecycle data stored in the data warehouse 104. As depicted, the data flow 200 further includes a part definition system 212 at the ISA-95 level 3. The part definition system 212 can generate a three-dimensional CAD (computer aided design) part, for example a 3D CAD definition of a shim, for inclusion in the PLM system 102. In such examples, the product lifecycle data 204 can include measured laser-scanned data of the corresponding fabricated shim or other suitable data. FIG. 2 is illustrative. In other examples, another data flow can be used.

As mentioned herein above, a PLM system can utilize a product object model for managing a BOM structure of a product line. Therefore, FIG. 3 illustrates a block diagram of an example product object model 300. The product object model 108 is an example of the product object model 300. Here, the product object model 300 includes a product class 302 that represents a product line, for example, an aircraft type. As depicted, the product class 302 includes a product line object 304 that represents a specific aircraft. Additionally, the product line object 304 comprises a first part reference object 306 representing a specific part on the specific aircraft.

A part reference object can include product definition data that is defined by attributes, such as parts description, materials, and/or acceptable tolerances, for example. The product definition data can also be described by drawings, CAD models, performance specifications, product lifecycle data, and the like, for example. Thus, the first part reference object 306 comprises a primary representation 308 including a part object in the form of three-dimensional CAD geometry 310, or CAD file. The first part reference object 306 also comprises a first supplementary representation 312 of additional relevant data. Specifically, the first supplementary representation 312 includes a first pointer 314 to a first storage location 316 of product lifecycle data associated with the first part reference object 306. Here, the first storage location 316 is in the data warehouse 104 as discussed herein above. In such a configuration, the product lifecycle data can be linked to the first part reference object 306 while not overwhelming the product object model 300 with large data files. In other examples, the first part reference object 306 can include additional supplementary representations comprising corresponding additional pointers.

Likewise, the product line object 304 also comprises a second part reference object 318 representing a second specific part on the specific aircraft. Further, the second part reference object 318 comprises a primary representation 320 and a supplementary representation 322. Here, the supplementary representation 322 includes a second pointer 324 to a second storage location 326 of second product lifecycle data associated with the second part reference object 318. FIG. 3 is illustrative. While discussed with reference to an aircraft product line, a product object model can represent another product line. In further examples, a product object model may have another configuration.

FIG. 4 schematically depicts an example communication flow 400 for transferring the product lifecycle data into the data warehouse 104. Here, the communication flow 400 is discussed with reference to the computing system 100, but can be used with other computing systems. As depicted, the data warehouse 104 is in a lockdown mode such that the control gate module 116 exclusively controls access to the data warehouse 104. In other examples, the control gate module 116 can be configured to control access to the data warehouse 104 in another suitable manner. Briefly, the communication flow 400 transfers the product lifecycle data to the data warehouse 104 over various secure connections. Here, a system interface between the verdict retriever module 112 and the control gate module 116 is especially beneficial to be configured as a secure connection.

At the user agent module 114, the communication flow 400 sends a change data request for a part reference object in the PLM system 102. The change data request can include a request to add, delete, or update at least a portion of the product lifecycle data related to the part reference object. In various examples, an end-user and/or another module (not depicted in FIG. 4) can trigger the change data request. Further, at the verdict retriever module 112, the communication flow 400 sends, to the PLM system 102, a verdict request based at least upon the change data request. In some examples, the verdict request comprises a request for an access control verdict as discussed with reference to FIG. 6. Alternatively or additionally, the verdict request can include a request for a configuration management verdict as discussed with reference to FIG. 7. In response, the communication flow 400 receives a verdict response from the PLM system 102.

Additionally, the communication flow 400 establishes, at the verdict retriever module 112, the secure connection with the control gate module 116. As depicted, the communication flow 400 initiates an asymmetric public-key session from the verdict retriever module 112 and exchanges one or more session keys. Further, the communication flow 400 sends a request to publish the product lifecycle data and forwards the verdict response from the PLM system 102 to the control gate module 116. In other examples, other suitable information can also be sent to the control gate module 116. The control gate module 116 enforces the verdict response obtained from the PLM system 102. As depicted, the communication flow 400 sends, to the verdict retriever module 112, a pointer in the form of a URL to a storage location in the data warehouse 104 along with a one-time permission key when the verdict response includes an approve response. Here, the one-time permission key is a digital secret that only the data warehouse 104 can decipher. In other examples, another suitable permission key can be used. Further, the communication flow 400 also forwards the verdict response to the user agent module 114.

Continuing, the communication flow 400 receives, at the verdict retriever module 112, the product lifecycle data from the user agent module 114. In response, the verdict retriever module 112 sends the product lifecycle data along with the one-time permission key to the control gate module 116 over the secure connection. The communication flow 400 further transfers, at the control gate module 116, the product lifecycle data to the storage location in the data warehouse 104 upon validation of the one-time permission key. Additionally, the communication flow 400 transfers to the PLM system 102, at the verdict retriever module 112, the pointer to the storage location to record the pointer in the BOM structure as discussed herein above. In examples where the verdict response comprises a deny response, the communication flow 400 can send the deny response to the user agent module 114 and terminate the communication thread with the user agent module 114. FIG. 4 is illustrative. In other examples, another communication flow may be used.

As mentioned herein above, the product lifecycle data is transferred to the control gate module 116 over a secure connection. Thus, FIG. 5 schematically depicts an example security architecture 500. Here, the security architecture 500 is discussed with reference to the computing system 100, but can be used with other computing systems. In the current example, a secure connection 502 is established between the verdict retriever module 112 and the control gate module 116. In other examples, a secure connection can be established between the control gate module 116 and the user agent module 114 in a likewise manner to the security architecture 500. Briefly, the security architecture 500 provides a mechanism for the verdict retriever module 112 to authenticate the control gate module 116, and the control gate module 116 to authenticate the verdict retriever module 112. This helps to enable a trust relationship between the verdict retriever module 112 and the control gate module 116.

More particularly, the security architecture 500 includes a certificate authority server 504 to issue asymmetric keys for exchange with the verdict retriever module 112 and the control gate module 116. Here, the secure connection 502 is established after a successful exchange of keys 506. In the current example, the certificate authority server 504 is configured to use a X.509 certificate authority specified by the International Telecommunication Union (ITU). In other examples, the certificate authority server 504 can have another configuration. As depicted, the security architecture 500 includes a trust anchor 508 coupled to the certificate authority server 504. The trust anchor 508 can be configured as an authoritative entity for which trust is assumed and not derived. In examples with a moderately-high level of trust, a key comprising a X.509 specified cryptographic key can be stored in a file system of a host computing system for the certificate authority. In examples with the highest level of trustworthiness currently available in modern computing systems, the trust anchor 508 can be implemented on a computer chip, such as with a trusted platform module (TPM). Such a configuration helps to provide a significantly high protection against tampering of the secure connection 502. FIG. 5 is illustrative. In other examples, another security architecture may be used.

As discussed herein above, the verdict retriever module 112 extracts a verdict response from the PLM system 102. In some examples, the verdict response can include an access control verdict, for example, indicating whether the data change request has access authorization. Thus, FIG. 6 illustrates an example communication flow 600 for requesting the access control verdict. Here, the communication flow 600 is discussed with reference to the computing system 100, but can be used with other computing systems. At the verdict retriever module 112, the communication flow 600 receives a change data request for a part reference object in the PLM system 102. In the depicted example, the change data request includes a request for access control authorization 602. Further, the communication flow 600 sends an inquiry for authorization 604 to the PLM system 102 based at least upon the request for access control authorization 602. In response, the communication flow 600 receives a reply 606 indicating a verdict response. As depicted, the verdict response includes either an approve response or a deny response. In some examples with the deny response, the verdict response can further include a reason or error code 608. In some examples with the approve response, the verdict response can further include, not shown in FIG. 6, a permission key, such as a one-time permission key, for example. Additionally, the communication flow 400 sends the verdict response and optionally the reason or error code to the user agent module 114, as indicated by 610. In such a manner, the verdict retriever module 112 obtains an access control verdict. The communication flow 600 is illustrative. In other examples, a verdict retriever module can be configured to automatically initiate an inquiry to a PLM system for authorization without a user agent module explicitly requesting access-control authorization. In further examples, the verdict retriever module 112 may obtain the verdict response in another suitable manner.

In the above example, the verdict retriever module 112 obtains the verdict response indicating whether the data change request has access to the part reference object in the PLM system 102. Alternatively or additionally, the verdict response can indicate whether the part reference object is in a configuration, or state, that is authorized for a change. As such, FIG. 7 schematically depicts an example communication flow 700 for requesting such a configuration management verdict. Here, the communication flow 700 is discussed with reference to the computing system 100, but can be used with other computing systems. At the user agent module 114, the communication flow 700 sends a change data request for a part reference object in the PLM system 102 as discussed herein above. In the depicted example, the change data request includes a request for configuration management authorization 702.

At the verdict retriever module 112, the communication flow 700 sends, to the PLM system 102, a series of inquiries 704 based at least upon the change data request. In the current example, the inquiries 704 relate to a configuration of the part reference object within a product object model, such as discussed with reference to FIG. 3, for example. As depicted, the communication flow 700 receives a corresponding status reply 706 in response to each inquiry 704 sent. As a specific example, the communication flow 700 can send a CAD part object inquiry 704A for whether a CAD part object has been attached to the part reference object in the PLM system 102. Further, the corresponding status reply 706 can include a positive reply, in which instance the communication flow 700 moves to the next inquiry. Alternatively, the corresponding status reply 706 can include a negative reply. As a specific example, the communication flow 700 can respond with a deny verdict and reason or error code to the user agent module 114, and terminate the communication in response to the negative reply.

Continuing at the verdict retriever module 112, the communication flow 700 sends a CAD attribute inquiry 704B to ascertain existence of specified attributes on the CAD part, and also sends a CAD state inquiry 704C to ascertain whether the CAD part has been promoted to the correct state (e.g., “released” or “approved”). As mentioned herein above, attributes define product definition data for the part reference object. The communication flow 700 can also send one or more inquiries on whether a particular object is attached to the CAD part object in the PLM system 102. In the depicted example, these inquires include a document object inquiry 704D, a part reference object inquiry 704E, a product line object inquiry 704F, and a product class inquiry 704G. In other examples, the communication flow 700 may send additional inquiries and/or omit one or more of the depicted inquiries.

Additionally, the communication flow 700 sends, to the user agent module 114, a verdict response 708 based at least upon one or more of the corresponding status replies 706. For example, when the status replies are positive replies, the verdict response 708 can include an approve response. In other examples, the verdict response can include a deny response when one or more of the status replies comprises the negative reply. In some such examples, the verdict response 708 can include a reason or error code 710. As a specific example, the communication flow 700 can respond with a deny verdict and reason or error code to the user agent module 114 and also terminate the communication in response to the negative reply. FIG. 7 is illustrative. In other examples, a verdict retriever module can be configured to automatically initiate an inquiry to a PLM system for authorization without a user agent module explicitly requesting configuration-management authorization. In further examples, another communication flow for obtaining the configuration management verdict may be used.

As mentioned herein above, the user agent module 114 can send product lifecycle data to the control gate module 116. Thus, FIG. 8 schematically depicts an example communication flow 800 for an alternate transfer of product lifecycle data into the data warehouse 104. As discussed with reference to FIG. 4, the user agent module 114 transfers the product lifecycle data to the verdict retriever module 112 which, in turn, transfers the product lifecycle data to the control gate module 116. In contrast, the communication flow 800 directly transfers the product lifecycle data to the control gate module 116 from the user agent module 114. Here, the communication flow 800 is discussed with reference to the computing system 100, but can be used with other computing systems. More particularly, in a likewise manner to the communication flow 400, the communication flow 800 receives, at the verdict retriever module 112, a change data request for a part reference object in the PLM system 102. Further, the communication flow 800 sends, to the PLM system 102, a verdict request based at least upon the change data request, and in response, receives a verdict response. Additionally, the communication flow 800 sends a request to publish data along with the verdict response from the PLM system 102 to the control gate module 116 and, in response, receives a pointer in the form of a URL to a storage location in the data warehouse 104 along with a permission key in the form of a one-time permission key when the verdict response includes an approve response.

In contrast to FIG. 4, the communication flow 800 receives, at the user agent module 114, the verdict response and the URL along with the one-time permission key from the verdict retriever module 112. Here, the one-time permission key is a digital secret that only the data warehouse 104 can decipher. Continuing at the user agent module 114, the communication flow 800 establishes a secure connection utilizing an asymmetric public-key session with the control gate module 116. Further, the communication flow 800 transfers the product lifecycle data along with the one-time permission key over the secure connection to the control gate module 116 and into the data warehouse 104. In such a manner, the product lifecycle data can travel from the user agent module 114 to the control gate module 116 without traversing through the verdict retriever module 112. This can help to reduce load on the verdict retriever module 112 and/or network connections in the computing system 100 which, in turn, may result in a comparatively quicker upload time into the data warehouse 104 versus if the product lifecycle data traverses the verdict retriever module 112. It will be understood by those of ordinary skill in the art without undue experimentation that such a configuration comes with a tradeoff of additional complexity on the design of the user agent module 114. Further, the communication flow 800 transfers, at the verdict retriever module 112, the URL to the PLM system 102 to record the pointer in relation to the part reference object in the BOM structure as discussed herein above. FIG. 8 is illustrative. In other examples, another communication flow may be used.

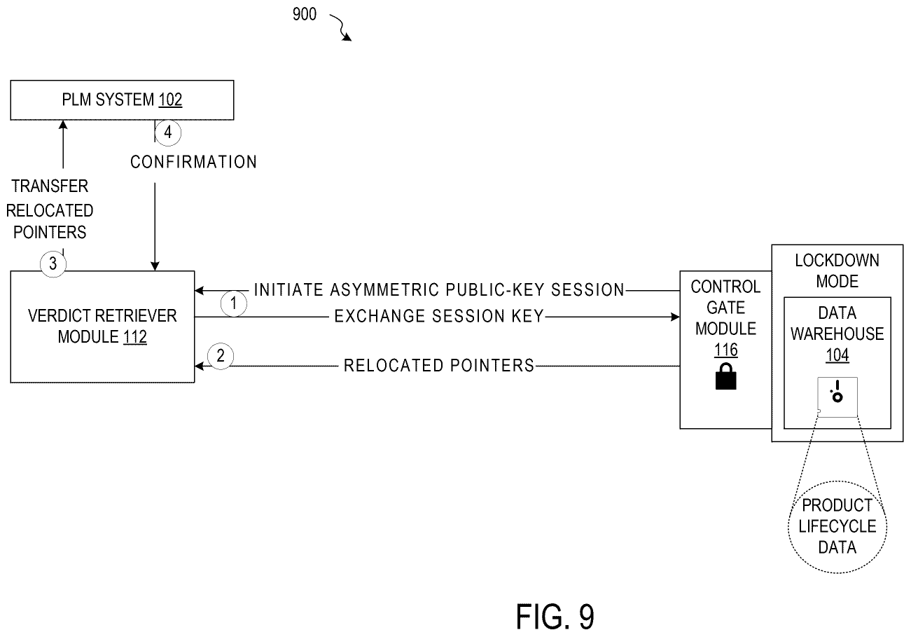

In the above examples, product lifecycle data is transferred into the data warehouse 104. In other examples, the product lifecycle data can be moved to new storage locations within the data warehouse 104, referred to as data migration. For example, the data migration can be performed during maintenance of the data warehouse 104, such as when hardware is upgraded, for example. As another example, data migration can be performed to relocate stored data to other hardware for greater storage capacity. FIG. 9 schematically depicts an example communication flow 900 for updating pointers in the PLM system 102 resulting from data migration. Here, the communication flow 900 is discussed with reference to the computing system 100, but can be used with other computing systems. After data migration, the product lifecycle data has been moved to updated storage locations in the data warehouse 104. As such, the pointers in the PLM system 102 can become broken. To address such stale pointers, one or more of the stale pointers in the PLM system 102 are updated with a corresponding one or more relocated pointers to reflect the new storage locations. In some examples, the communication flow 900 can be human triggered after the data migration. Alternatively or additionally, the communication flow 900 can be triggered by an automated monitoring program (e.g., a daemon) hosted by the control gate module 116 or in/via another suitable manner.

As depicted, the communication flow 900 initiates, at the control gate module 116, an asymmetric public-key session with the verdict retriever module 112 and exchanges one or more session keys. In such a manner, a secure connection is established between the control gate module 116 and the verdict retriever module 112. In other examples, the secure connection can be established in another suitable manner. The communication flow 900 sends the plurality of relocated pointers over the secure connection to the verdict retriever module 112. At the verdict retriever module 112, the communication flow 900 transfers the plurality of relocated pointers to the PLM system 102 to replace the stale pointers in the PLM system 102. In response, the communication flow 900 receives a confirmation that can indicate, for example, a successful replacement of the plurality of relocated pointers into the PLM system 102. In other examples, the communication flow 900 can alternatively receive one or more error messages indicating one or more errors in replacing the pointers in the PLM system 102. FIG. 9 is illustrative. In other examples, another communication flow may be used for updating pointers in the PLM system 102.

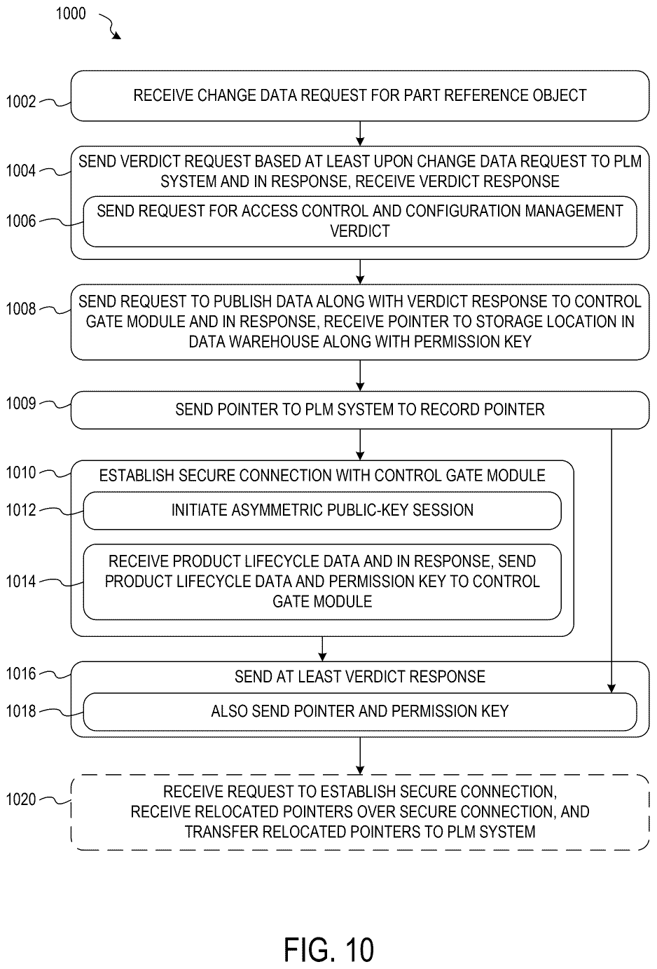

A verdict retriever module can be configured to programmatically interface with suitable PLM systems. As such, FIG. 10 shows a flowchart of an example method 1000 for operating a verdict retriever module. The method 1000 can be performed on the computing system 100, for example. The method 1000 comprises, at 1002, receiving a change data request for a part reference object in a PLM system. The change data request can be received from a user agent module in an inspection/measurement system or another suitable source. The method 1000 further comprises, at 1004, sending a verdict request based at least upon the change data request to the PLM system and in response, receiving a verdict response. The verdict response can include an approve response, a deny response, and/or another suitable response. In some examples, sending the verdict request comprises sending a request for an access control and configuration management verdict, as indicated at 1006. Additionally, the method 1000 comprises, at 1008, sending a request to publish data along with the verdict response to a control gate module and in response, receiving a pointer to a storage location in a data warehouse along with a permission key. The method 1000 additionally comprises, at 1009, sending the pointer to the PLM system to record the pointer in relation to the part reference object in the PLM system.

The method 1000 can optionally comprise, at 1010, establishing a secure connection with the control gate module before sending the request to publish data to the control gate module. In some such examples, establishing the secure connection with the control gate module comprises initiating an asymmetric public-key session and exchanging a session key, as indicated at 1012. Further, the method 1000 can comprise, at 1014, receiving product lifecycle data associated with the change data request from the user agent module and in response, sending the product lifecycle data and the permission key to the control gate module over the secure connection in some examples. In other examples, 1010, 1012, and/or 1014 may be omitted.

The method 1000 also includes, at 1016, sending at least the verdict response to a source of the change data request, such as the user agent module, for example. In examples where 1010 is omitted, sending at least the verdict response can comprise also sending the pointer and the permission key, as indicated at 1018.

As mentioned herein above, data migration can move the product lifecycle data to new storage location(s) in the data warehouse, in some examples. In some such examples, the method 1000 can also include, at 1020, receiving a request to establish a secure connection from the control gate module, receiving a plurality of relocated pointers from the control gate over the secure connection, and transferring the plurality of relocated pointers to the PLM system.

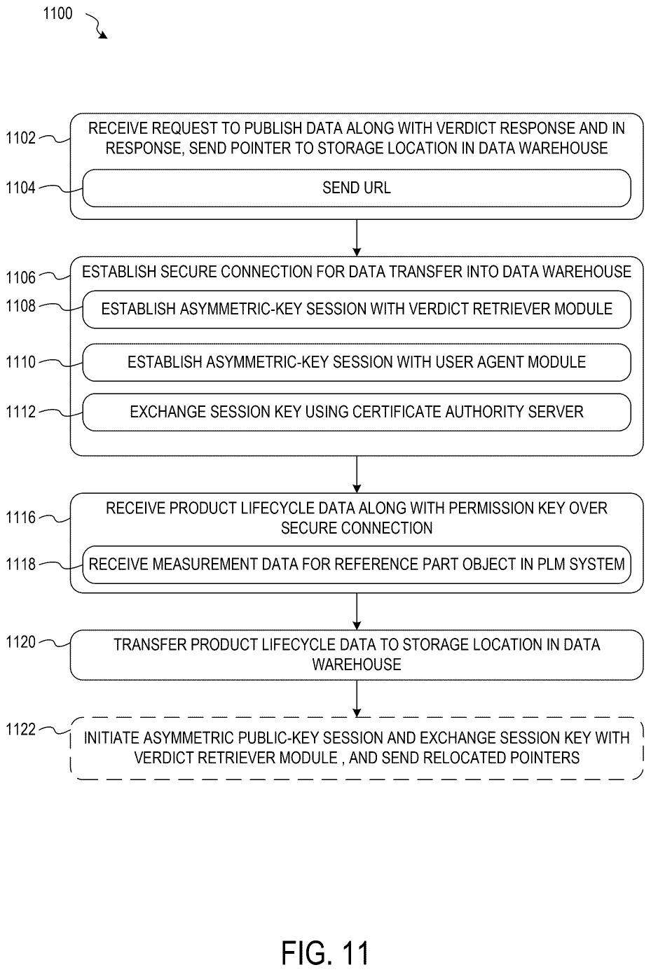

As mentioned previously above, the verdict retriever module communicates with a control gate module. Therefore, FIG. 11 illustrates a flowchart of an example method 1100 for operating a control gate module operatively coupled to at least a data warehouse. For example, the method 1100 can be performed by the computing system 100. The method 1100 comprises, at 1102, receiving, from a verdict retriever module, a request to publish data along with the verdict response and in response, sending a pointer to a storage location in the data warehouse along with a permission key. In some examples, sending the pointer can comprise sending a URL to the storage location in the data warehouse, as indicated at 1104. In other examples, the pointer may have another configuration.

The method 1100 further comprises, at 1106, establishing a secure connection for data transfer into the data warehouse. In some examples where the verdict retriever module acts as intermediary for data transfer, establishing the secure connection comprises establishing an asymmetric-key session with the verdict retriever module, as indicated at 1108. In other examples where data is transferred from a user agent module, establishing the secure connection can comprise establishing an asymmetric-key session with the user agent module, as indicated at 1110. Here, establishing the secure connection comprises exchanging a session key using a certificate authority server as indicated at 1112. In various examples, establishing the secure connection can comprise using a TPM for a trust anchor and/or store a key including a cryptographic key on a file system of a host computing system for the certificate authority.

The method 1100 additionally comprises, at 1116, receiving product lifecycle data along with the permission key over the secure connection. In some examples, receiving the product lifecycle data comprises receiving measurement data for a reference part object in a PLM system, as indicated at 1118. In other examples, other suitable product lifecycle data for the reference part object can be received. The method 1100 additionally comprises, at 1120, transferring the product lifecycle data to the storage location in the data warehouse.

As mentioned herein above, data migration can move the product lifecycle data to new storage location(s) in the data warehouse, in some examples. In some such examples, the method 1100 comprises, at 1122, initiating an asymmetric public-key session and exchanging a session key with the verdict retriever module in response to a data migration activity, and sending a plurality of relocated pointers to the verdict retriever module. In various examples, the data migration request can be triggered by a human or a data warehouse monitoring daemon.

A verdict retriever module and a control gate module as disclosed herein can enable retaining product lifecycle data in relation to BOM structures in a PLM system by using pointers. Such a configuration enables traceability of the product lifecycle data and lessens likelihood of data loss over time. Further, storing the product lifecycle data in a data warehouse and using the pointers is less likely to overwhelm the PLM system as compared to directly storing the product lifecycle data in the PLM system. Additionally, extracting a verdict response from the PLM system enables the product lifecycle data in the data warehouse to have similar access control and configuration management as the PLM system. This can significantly reduce the complexity and cost compared to replicating PLM access control and configuration management capabilities for the data warehouse.

In some embodiments, the examples described herein can be tied to a computing system of one or more computing devices. In particular, aspects of such methods and processes can be implemented as a computer-application program or service, an API, a library, and/or other computer-program product.

FIG. 12 schematically shows a non-limiting embodiment of a computing system 1200 that can enact one or more of the examples described above. Computing system 1200 is shown in simplified form. Computing system 1200 can take the form of one or more personal computers, server computers, tablet computers, network computing devices, mobile computing devices, mobile communication devices (e.g., smart phones), and/or other computing devices. In some examples, the computing system 100 is an example of the computing system 1200.

Computing system 1200 includes a logic subsystem 1202, a storage subsystem 1204, and an optional display subsystem 1206. Computing system 1200 can optionally include an input subsystem 1208, a communication subsystem 1210, and/or other computing-related components not shown in FIG. 12.

Logic subsystem 1202 includes one or more physical devices configured to execute instructions. For example, logic subsystem 1202 can be configured to execute instructions that are part of one or more applications, services, programs, routines, libraries, objects, components, data structures, or other logical constructs. Such instructions can be implemented to perform a task, implement a data type, transform the state of one or more components, achieve a technical effect, or otherwise arrive at a desired result. For example, logic subsystem 1202 can be used to execute instructions to perform the method 1000 of FIG. 10 and/or the method 1100 of FIG. 11.

Logic subsystem 1202 can include one or more processors configured to execute software instructions. Additionally or alternatively, logic subsystem 1202 can include one or more hardware or firmware logic machines configured to execute hardware or firmware instructions. Processors of logic subsystem 1202 can be single-core or multi-core, and the instructions executed thereon can be configured for sequential, parallel, and/or distributed processing. Individual components of logic subsystem 1202 optionally can be distributed among two or more separate devices, which can be remotely located and/or configured for coordinated processing. Aspects of logic subsystem 1202 can be virtualized and executed by remotely accessible, networked computing devices configured in a cloud-computing configuration.

Storage subsystem 1204 includes one or more physical devices configured to hold instructions executable by logic subsystem 1202 to implement the methods and processes described herein. When such methods and processes are implemented, the state of storage subsystem 1204 can be transformed—e.g., to hold different data. The storage subsystem 106 is an example of storage subsystem 1204.

Storage subsystem 1204 can include removable and/or built-in devices. Storage subsystem 1204 can include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 1204 can include volatile, nonvolatile, dynamic, static, read/write, read-only, random-access, sequential-access, location-addressable, file-addressable, and/or content-addressable devices.

It will be appreciated by those of ordinary skill in the art, without undue experimentation, that storage subsystem 1204 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 1202 and storage subsystem 1204 can be integrated together into one or more hardware-logic components. Such hardware-logic components can include field-programmable gate arrays (FPGAs), program-and application-specific integrated circuits (PASIC/ASICs), program-and application-specific standard products (PSSP/ASSPs), system-on-a-chip (SOC), and complex programmable logic devices (CPLDs), for example.

When included, a display subsystem 1206 can be used to present a visual representation of data held by storage subsystem 1204. This visual representation can take the form of a graphic user interface (GUI). As the herein described methods and processes change the data held by the storage subsystem 1204, and thus transform the state of the storage machine, the state of display subsystem 1206 can likewise be transformed to visually represent changes in the underlying data.

When included, a display subsystem 1206 can include one or more display devices utilizing virtually any type of technology. Such display devices can be combined with logic subsystem 1202 and/or storage subsystem 1204 in a shared enclosure, or such display devices can be peripheral display devices.

When included, input subsystem 1208 can comprise or interface with one or more user-input devices such as a keyboard, mouse, touch screen, or joystick. In some embodiments, the input subsystem 1208 can comprise or interface with selected natural user input (NUI) componentry. Such componentry can be integrated or peripheral, and the transduction and/or processing of input actions can be handled on-or off-board. Example NUI componentry can include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, and without respect to the dynamic and reconfigurable communication system described above, the communication subsystem 1210 can be configured to communicatively couple computing system 1200 with one or more other computing devices. Communication subsystem 1210 can include wired and/or wireless communication devices compatible with one or more different communication protocols. As non-limiting examples, the communication subsystem can be configured for communication via a wireless telephone network, or a wired or wireless local-or wide-area network. In some embodiments, communication subsystem 1210 can allow computing system 1200 to send and/or receive messages to and/or from other devices via a network such as the Internet. For example, communication subsystem 1210 can be used to receive or send data to another computing system.

Further, the disclosure comprises configurations according to the following examples.

Example 1. A method for operating a verdict retriever module configured to programmatically interface with a product lifecycle management (PLM) system, the method comprising receiving a change data request for a part reference object in the PLM system; sending a verdict request based at least upon the change data request to the PLM system and in response, receiving a verdict response; sending a request to publish data to a control gate module and in response, receiving a pointer to a storage location in a data warehouse; transferring the pointer to the PLM system to record the pointer in relation to the part reference object; and sending at least the verdict response to a source of the change data request.

Example 2. The method of example 1, further comprising establishing a secure connection with the control gate module before sending the request to publish data to the control gate module and the source of the change data request.

Example 3. The method of example 2, wherein establishing the secure connection with the control gate module comprises initiating an asymmetric public-key session and exchanging a session key.

Example 4. The method of example 2, further comprising receiving product lifecycle data associated with the change data request and in response, sending the product lifecycle data to the control gate module over the secure connection.

Example 5. The method of example 1, wherein sending at least the verdict response comprises also sending the pointer.

Example 6. The method of example 1, further comprising receiving a request to establish a secure connection from the control gate module, receiving a plurality of relocated pointers from the control gate over the secure connection, and transferring the plurality of relocated pointers to the PLM system.

Example 7. The method of example 1, wherein sending the verdict request comprises sending a request for an access control and configuration management verdict.

Example 8. A computing system comprising a logic subsystem; and a storage subsystem comprising a verdict retriever module executable by the logic subsystem to receive a change data request for a part reference object in a product lifecycle management (PLM) system; send a verdict request based at least upon the change data request to the PLM system and in response, receive a verdict response; send a request to publish data to a control gate module and in response, receive a pointer to a storage location in a data warehouse; transfer the pointer to the PLM system to record the pointer in relation to the part reference object; and send at least the verdict response to a source of the change data request.

Example 9. The computing system of example 8, wherein the verdict retriever module is further executable to establish a secure connection with the control gate module before sending the request to publish data to the control gate module.

Example 10. The computing system of example 9, wherein the verdict retriever module is executable to establish the secure connection with the control gate module by initiating an asymmetric public-key session and exchanging a session key.

Example 11. The computing system of example 9, wherein the verdict retriever module is further executable to receive product lifecycle data associated with the change data request and in response, send the product lifecycle data to the control gate module over the secure connection.

Example 12. The computing system of example 8, wherein the verdict retriever module is executable to send at least the verdict response by also sending the pointer.

Example 13. The computing system of example 8, wherein the verdict retriever module is further executable to receive a request to establish a secure connection from the control gate module, receive a plurality of relocated pointers from the control gate over the secure connection, and transfer the plurality of relocated pointers to the PLM system.

Example 14. The computing system of example 8, wherein the verdict retriever module is executable to send the verdict request by sending a request for an access control and configuration management verdict.

Example 15. A method for operating a control gate module operatively coupled to at least a data warehouse, the method comprising receiving, from a verdict retriever module, a request to publish data to the data warehouse and in response, sending a pointer to a storage location in the data warehouse; establishing a secure connection for data transfer into the data warehouse; receiving product lifecycle data over the secure connection; and transferring the product lifecycle data to the storage location in the data warehouse.

Example 16. The method of example 15, wherein receiving the request to publish the data comprises also receiving a verdict response from the verdict retriever module, and wherein the pointer to the storage location is sent when the verdict response comprises an approve response.

Example 17. The method of example 15, wherein establishing the secure connection comprises establishing an asymmetric-key session with the verdict retriever module.

Example 18. The method of example 15, wherein establishing the secure connection comprises establishing an asymmetric-key session with a user agent module.

Example 19. The method of example 15, wherein establishing the secure connection comprises exchanging a session key using a certificate authority server.

Example 20. The method of example 15, wherein sending the pointer comprises sending a uniform resource locator (URL) to the storage location in the data warehouse.

Example 21. The method of example 15, further comprising initiating an asymmetric public-key session and exchanging a session key with the verdict retriever module in response to a data migration request, and sending a plurality of relocated pointers to the verdict retriever module.

Example 22. The method of example 15, wherein receiving the product lifecycle data comprises receiving measurement data for a reference part object in a product lifecycle management (PLM) system.

Example 23. A computing system comprising a logic subsystem; and a storage subsystem comprising a product object model including at least a first part reference object having a primary representation and one or more supplementary representations, at least one supplementary representation of the one or more the supplementary representations comprising a pointer to a storage location of product lifecycle data associated with the first part reference object, the storage location being outside the product object model.

Example 24. The computing system of example 23, wherein the product object model further includes a second part reference object having a supplementary representation comprising a second pointer to a second storage location of product lifecycle data associated with the second part reference object.

Example 25. The computing system of example 23, wherein the pointer to the storage location comprises a first pointer to a first storage location, and an additional supplementary representation of the one or more supplementary representations comprising a second pointer to a second storage location of additional product lifecycle data associated with the first part reference object.

Example 26. The computing system of example 23, wherein the storage subsystem further comprises instructions executable by the logic subsystem to receive a relocated pointer for the at least one supplementary representation, the relocated pointer being to a different storage location than the pointer, and replace the pointer of the at least one supplementary representation with the relocated pointer.

Example 27. The computing system of example 23, wherein the pointer comprises a uniform resource locator (URL) to the storage location in a data warehouse.

Example 28. The computing system of example 23, further comprising a verdict module operatively coupled to the product object model, the verdict module being executable by the logic subsystem to determine an access control and configuration management decision for the first part reference object.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for operating a verdict retriever module configured to programmatically interface with a product lifecycle management (PLM) system, the method comprising:
receiving a change data request for a part reference object in the PLM system;
sending a verdict request based at least upon the change data request to the PLM system and in response, receiving a verdict response;
sending a request to publish data to a control gate module and in response, receiving a pointer to a storage location in a data warehouse;
transferring the pointer to the PLM system to record the pointer in relation to the part reference object; and
sending at least the verdict response to a source of the change data request.

2. The method of claim 1, further comprising establishing a secure connection with the control gate module before sending the request to publish data to the control gate module and the source of the change data request.

3. The method of claim 2, wherein establishing the secure connection with the control gate module comprises initiating an asymmetric public-key session and exchanging a session key.

4. The method of claim 2, further comprising receiving product lifecycle data associated with the change data request and in response, sending the product lifecycle data to the control gate module over the secure connection.

5. The method of claim 1, wherein sending at least the verdict response comprises also sending the pointer.

6. The method of claim 1, further comprising
receiving a request to establish a secure connection from the control gate module,
receiving a plurality of relocated pointers from the control gate over the secure connection, and
transferring the plurality of relocated pointers to the PLM system.

7. The method of claim 1, wherein sending the verdict request comprises sending a request for an access control and configuration management verdict.

8. A computing system comprising:
a logic subsystem; and
a storage subsystem comprising a verdict retriever module executable by the logic subsystem to
receive a change data request for a part reference object in a product lifecycle management (PLM) system;
send a verdict request based at least upon the change data request to the PLM system and in response, receive a verdict response;
send a request to publish data to a control gate module and in response, receive a pointer to a storage location in a data warehouse;
transfer the pointer to the PLM system to record the pointer in relation to the part reference object; and
send at least the verdict response to a source of the change data request.

9. The computing system of claim 8, wherein the verdict retriever module is further executable to establish a secure connection with the control gate module before sending the request to publish data to the control gate module.

10. The computing system of claim 9, wherein the verdict retriever module is executable to establish the secure connection with the control gate module by initiating an asymmetric public-key session and exchanging a session key.

11. The computing system of claim 9, wherein the verdict retriever module is further executable to receive product lifecycle data associated with the change data request and in response, send the product lifecycle data to the control gate module over the secure connection.

12. The computing system of claim 8, wherein the verdict retriever module is executable to send at least the verdict response by also sending the pointer.

13. The computing system of claim 8, wherein the verdict retriever module is further executable to
receive a request to establish a secure connection from the control gate module,
receive a plurality of relocated pointers from the control gate over the secure connection, and
transfer the plurality of relocated pointers to the PLM system.

14. The computing system of claim 8, wherein the verdict retriever module is executable to send the verdict request by sending a request for an access control and configuration management verdict.

15. A method for operating a control gate module operatively coupled to at least a data warehouse, the method comprising:
receiving, from a verdict retriever module, a request to publish data to the data warehouse and in response, sending a pointer to a storage location in the data warehouse;
establishing a secure connection for data transfer into the data warehouse;
receiving product lifecycle data over the secure connection; and
transferring the product lifecycle data to the storage location in the data warehouse.

16. The method of claim 15, wherein receiving the request to publish the data comprises also receiving a verdict response from the verdict retriever module, and wherein the pointer to the storage location is sent when the verdict response comprises an approve response.

17. The method of claim 15, wherein establishing the secure connection comprises establishing an asymmetric-key session with the verdict retriever module.

18. The method of claim 15, wherein establishing the secure connection comprises establishing an asymmetric-key session with a user agent module.

19. The method of claim 15, wherein establishing the secure connection comprises exchanging a session key using a certificate authority server.

20. The method of claim 15, wherein sending the pointer comprises sending a uniform resource locator (URL) to the storage location in the data warehouse.

21. The method of claim 15, further comprising
initiating an asymmetric public-key session and exchanging a session key with the verdict retriever module in response to a data migration request, and
sending a plurality of relocated pointers to the verdict retriever module.

22. The method of claim 15, wherein receiving the product lifecycle data comprises receiving measurement data for a reference part object in a product lifecycle management (PLM) system.

23. A computing system comprising:
a logic subsystem; and
a storage subsystem comprising a product object model including at least a first part reference object having a primary representation and one or more supplementary representations,
at least one supplementary representation of the one or more the supplementary representations comprising a pointer to a storage location of product lifecycle data associated with the first part reference object, the storage location being outside the product object model.

24. The computing system of claim 23, wherein the product object model further includes a second part reference object having a supplementary representation comprising a second pointer to a second storage location of product lifecycle data associated with the second part reference object.

25. The computing system of claim 23, wherein the pointer to the storage location comprises a first pointer to a first storage location, and an additional supplementary representation of the one or more supplementary representations comprising a second pointer to a second storage location of additional product lifecycle data associated with the first part reference object.

26. The computing system of claim 23, wherein the storage subsystem further comprises instructions executable by the logic subsystem to
receive a relocated pointer for the at least one supplementary representation, the relocated pointer being to a different storage location than the pointer, and
replace the pointer of the at least one supplementary representation with the relocated pointer.

27. The computing system of claim 23, wherein the pointer comprises a uniform resource locator (URL) to the storage location in a data warehouse.

28. The computing system of claim 23, further comprising a verdict module operatively coupled to the product object model, the verdict module being executable by the logic subsystem to determine an access control and configuration management decision for the first part reference object.
